(19) United States
(12) Patent Application Publication
(10) Pub. No.: US 2010/0328361 A1
(43) Pub. Date: Dec. 30, 2010

(54) Display Device and Display Method

(76) Inventor: Kimio Kajiyama, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/781,685

(22) Filed: May 17, 2010

(30) Foreign Application Priority Data
Jun. 30, 2009 (JP) 2009-156001

(51) Int. Cl. G09G 5/10; G09G 3/36

(52) U.S. Cl. 345/690; 345/102

(57) ABSTRACT

According to one embodiment, a display device includes a brightness controller and a display module. The brightness controller is configured to be capable of controlling a brightness of a backlight, which is configured to light sources, in units of a predetermined area corresponding to at least one light source, and configured to control at a first brightness at least one light source constituting a first light source area corresponding to a selected area on a display area, and configured to control at a second brightness at least one light source constituting a second light source area corresponding to a non-selected area on the display area. The display module is configured to display the selected area in accordance with the control at the first brightness by the brightness controller, and configured to display the non-selected area in accordance with the control at the second brightness by the brightness controller.

### CROSS-REFERENCE TO RELATED APPLICATIONS

This application is based upon and claims the benefit of priority from Japanese Patent Application No. 2009-156001, filed Jun. 30, 2009, the entire contents of which are incorporated herein by reference.

### FIELD

Embodiments described herein relate generally to a brightness control technique for improving visibility and reducing energy consumption.

### BACKGROUND

At present, liquid crystal display devices have been used as image display means of TVs, personal computers, mobile phones, etc. The liquid crystal display device comprises a liquid crystal panel and a backlight which is disposed on the back side of the liquid crystal panel. Since the liquid crystal panel itself emits no light, the backlight illuminates the liquid crystal panel, thereby displaying an image.

In recent years, there has been much to be desired in liquid crystal display devices, and various techniques have been proposed. For example, there is known a technique of controlling the brightness of a backlight source in relation to the characteristic amount of an input video signal. Furthermore, Jpn. Pat. Appln. KOKAI Publication No. 2007-241250 (patent document 1) discloses a liquid crystal display device which is able to stop the brightness control of the backlight source in relation to the characteristic amount of the input video signal in the case where multi-screen display is performed.

However, what is desired in liquid crystal display devices is not limited to the above, and there has been a demand for a display device which is excellent in visibility and reduction in energy consumption. For example, in the case of effecting multi-screen display, it is difficult to understand which of the screens has an operation right (i.e. it is difficult to understand which screen is the screen that is currently being selected), and there is a request for an improvement on such poor visibility. In addition, there is a demand for reduction in energy consumption. The above-mentioned patent document, however, is silent on the technique that meets these requests.

### BRIEF DESCRIPTION OF THE DRAWINGS

FIG. 1 schematically shows an example of the structure of a liquid crystal display device according to an embodiment;

FIG. 2 schematically shows an example of the structure of a backlight panel and a liquid crystal panel, which constitute the liquid crystal display device shown in FIG. 1;

FIG. 3 schematically shows an example of the structure of a light source region of the backlight panel of the liquid crystal display device shown in FIG. 1;

FIG. 4A shows an example of 2-screen display;

FIG. 4B shows an example of the state in which a selected screen (a screen with an operation right) of the 2-screen display is controlled at a first brightness, and a non-selected screen (a screen without an operation right) is controlled at a second brightness which is lower than the first brightness;

FIG. 4C shows an example in which brightness control is executable in units of a block;

FIG. 5 shows an example of the state in which a selected item of items on a menu screen, which is focused by a cursor, is controlled at a first brightness, and the other items, excluding the selected item, are controlled at a second brightness which is lower than the first brightness;

FIG. 6 shows an example of the state in which a selected item of items on a menu screen, which is focused by a cursor, is controlled at a first brightness, and the area excluding the selected item is controlled at a second brightness which is lower than the first brightness;

FIG. 7 shows an example of an energy-saving setting screen; and

FIG. 8 shows an example of an area control setting screen.

### DETAILED DESCRIPTION

In general, according to one embodiment, a display device includes a brightness controller and a display module. The brightness controller is configured to be capable of controlling a brightness of a backlight, which is configured to light sources, in units of a predetermined area corresponding to at least one light source, and configured to control at a first brightness at least one light source constituting a first light source area corresponding to a selected area on a display area, and configured to control at a second brightness at least one light source constituting a second light source area corresponding to a non-selected area on the display area. The display module is configured to display the selected area in accordance with the control at the first brightness by the brightness controller, and configured to display the non-selected area in accordance with the control at the second brightness by the brightness controller.

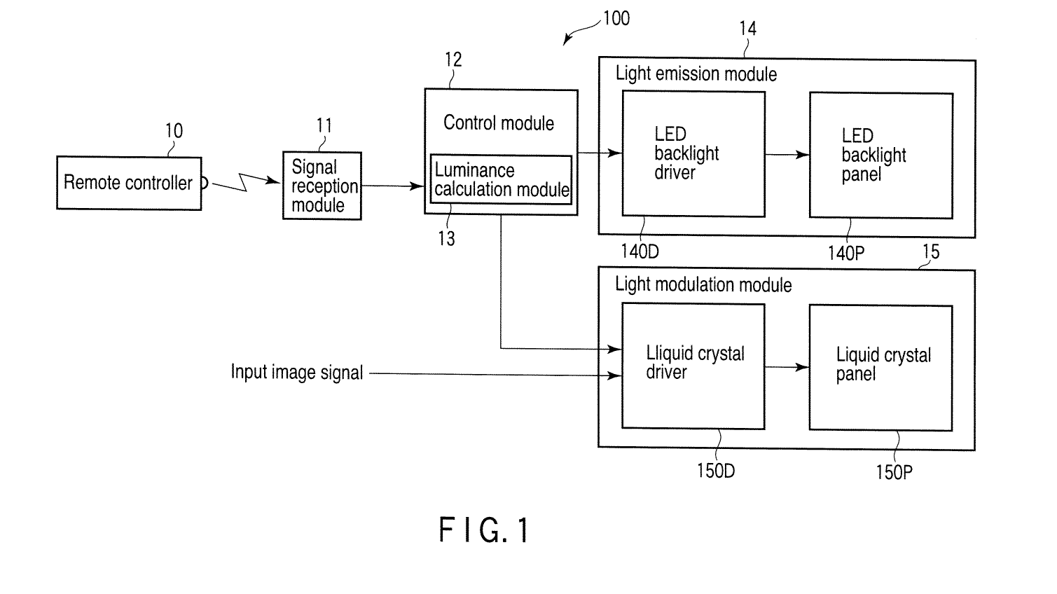

FIG. 1 schematically shows the structure of a liquid crystal display device according to an embodiment. As shown in FIG. 1, a liquid crystal display device 100 comprises a signal reception module 11, a control module 12, a luminance calculation module 13, a light emission module 14 and a light modulation module 15.

The signal reception module 11 receives an operation signal from a remote controller 10, and sends the received operation signal to the control module 12. The control module 12 controls the light emission module 14 and light modulation module 15, for example, in accordance with a display state.

The light emission module 14 comprises an LED backlight driver 140D and an LED backlight panel 140P. The LED backlight panel 140P is composed of light sources (LEDs). The LED backlight driver 140D controls the emission light luminance of each light source on the basis of a luminance value (light source turn-on value) for each light source from the luminance calculation module 13. The luminance calculation module 13 calculates the luminance value of each light source on the basis of an input image signal, and inputs the calculated luminance value to the LED backlight driver 140D.

The light modulation module 15 comprises a liquid crystal driver 150D and a liquid crystal panel 150P. The liquid crystal driver 150D controls the modulation of light from each light source by the liquid crystal panel 150P, on the basis of an input image signal or a corrected input image signal. Specifically, the liquid crystal driver 1500 controls the transmissivity of the liquid crystal panel 150P. Thereby, an image based on the input image signal is displayed on the liquid crystal panel 150P. In the liquid crystal display device 100, the display timing of an image by the liquid crystal panel 150P is synchronized with the turn-on timing of each light source.

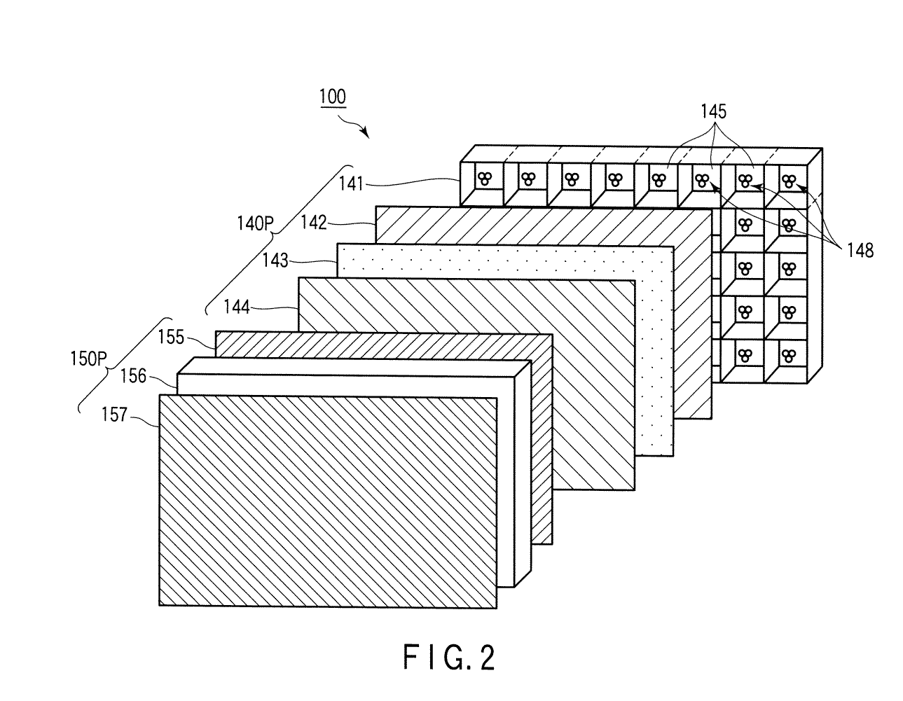

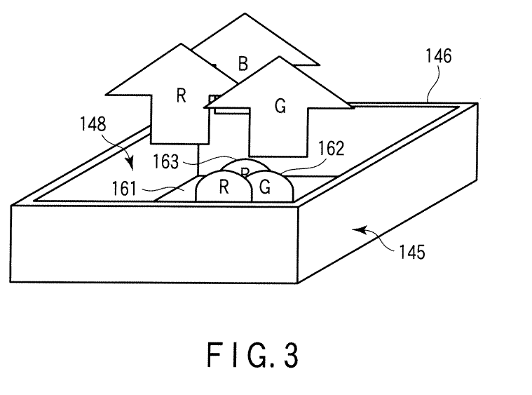

Referring to FIG. 2 and FIG. 3, a detailed description is given of the backlight panel 140P and liquid crystal panel 150P which constitute the liquid crystal display device 100 shown in FIG. 1. FIG. 2 is an exploded perspective view showing the structure of the backlight panel 140P and liquid crystal panel 150P of the liquid crystal display device 100. FIG. 3 is a perspective view showing the structure of the light source constituting the backlight panel 140P.

The backlight panel 140P comprises a light emission module 141, and a pair of diffusion plates 142 and 144 which are disposed in front of the light emission module 141 and sandwich a prism sheet 143. The light emission module 141 has a panel shape and has a matrix structure wherein light source regions 145 are regularly arranged in a matrix of M rows and N columns. FIG. 2 shows, by way of example, the light emission module 141 including light source regions 145 in five rows and eight columns.

The light source region 145, as shown in FIG. 3, is surrounded on the four sides by a partition wall 146 which extends in a direction of overlapping with the diffusion plate 142, etc. A light source 148 comprising three LEDs of the three RGB primary colors is disposed in each light source region 145. The light source 148 comprises the red LED 161, green LED 162 and blue LED 163, and emits light toward the front surface (liquid crystal panel 150P) while mixing the three colors of red, green and blue. The back surface of the liquid crystal panel 150 is illuminated with emission light from each light source region 145, and an image is displayed by adjusting the transmission of the emission light through the liquid crystal panel 150P.

The liquid crystal display device 100 is of a direct backlight type in which the entire surface of the backlight panel 140P is caused to emit light by the plural light sources 148 disposed in the light source regions 145, thereby illuminating the back surface of the liquid crystal panel 150P. The liquid crystal panel 150P comprises a pair of polarizer plates 155 and 157 and a liquid crystal 156 which is interposed between the polarizer plates 155 and 157.

Referring back to FIG. 1, a description is given of the brightness control of a selected area and a non-selected area by the LED backlight panel 140P.

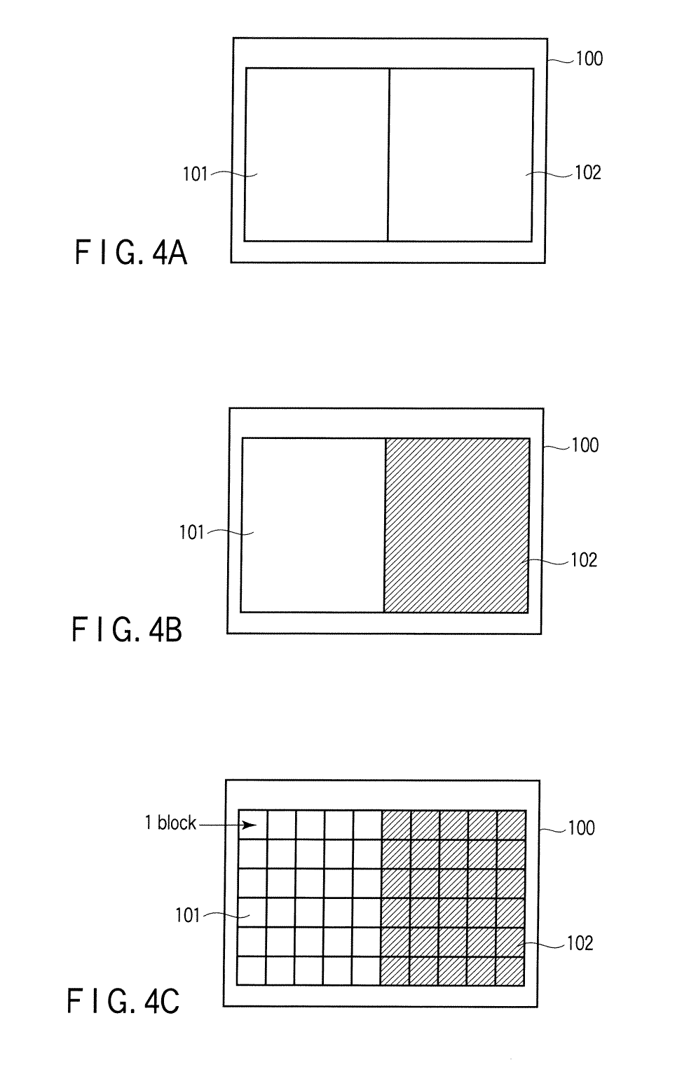

For example, as shown in FIG. 4A, the liquid crystal display device 100 can display an image by dividing the screen into two screens, on the basis of a 2-screen display instruction from the remote controller 10. For example, an image corresponding to channel 1 can be displayed on a first screen 101, and an image corresponding to channel 2 can be displayed on a second screen 102. In the present embodiment, an example of 2-screen display is described, but the invention is applicable to multi-screen display of more than two screens. Examples of the multi-screen display are 4-screen display, 8-screen display and 16-screen display.

The remote controller 10 is not able to operate (control) the first screen 101 and second screen 102 at the same time. The remote controller 10 can operate only one of the first screen 101 and second screen 102, which has an operation right. The remote controller 10 can transfer the operation right from the first screen 101 to the second screen 102, or from the second screen 102 to the first screen 101. In addition, the control module 12 executes management as to which of the first screen 101 and second screen 102 has the operation right.

For example, assume the case in which the first screen 101 which displays an image corresponding to channel 1 has the operation right, and the second screen 102 which displays an image corresponding to channel 2 does not have the operation right. In other words, assume the case in which the control module 12 executes such management that the first screen 101 has the operation right.

In this case, if the remote controller 10 instructs switching to channel 4, the first screen 101 displays an image corresponding to channel 4, and the second screen 102 continues to display the image corresponding to channel 2. Immediately after an operation (e.g. 5 seconds after an operation), the first screen 101 displays such characters as “IN OPERATION” by an OSD (On-Screen Display) function, and informs the user that the first screen 101 has the operation right.

However, if a predetermined time has passed since the operation, the characters “IN OPERATION” may disappear. In such a case, the user cannot easily understand which of the first screen 101 and second screen 102 has the operation right.

To cope with this problem, as shown in FIG. 4B, the liquid crystal display device 100 of the present embodiment controls at a first brightness at least one light source constituting the first light source area, which corresponds to a selected area (the screen with the operation right) in the display area, and controls at least one light source constituting the second light source area, which corresponds to a non-selected area (the screen without the operation right), at a second brightness which is lower than the first brightness. The brightness is controlled by the control module 12, luminance calculation module 13 and LED backlight driver 140D. In the description below, the statement to the effect that “at least one light source constituting the first light source area corresponding to the selected area is controlled at the first brightness” may simply be referred to as “the selected area is controlled at the first brightness”. Similarly, the statement to the effect that “at least one light source constituting the second light source area corresponding to the non-selected area is controlled at the second brightness which is lower than the first brightness” may simply be referred to as “the non-selected area is controlled at the second brightness”.

The control module 12 reports to the luminance calculation module 13, for example, the fact that the first screen 101 has the operation right, the area information of the first screen 101 in the entire display area, and the area information of the second screen 102. The luminance calculation module 13 calculates a luminance value for each light source corresponding to the area of the first screen 101 having the operation right (a luminance value corresponding to the first brightness) and a luminance value for each light source corresponding to the area of the second screen 102 having no operation right (a luminance value corresponding to the second brightness), and reports these luminance values to the LED backlight driver 140D. On the basis of the luminance values for the respective light sources from the luminance calculation module 13, the LED backlight driver 140D controls the emission light luminances of the respective light sources.

As shown in FIG. 4C, since the liquid crystal display device 100 can control the brightness in units of the area (light source region 145) corresponding to the light source, the liquid crystal display device 100 can control, on the basis of the above-described emission light luminance control, at least one light source constituting the first light source area, which corresponds to the first screen 101 having the operation right, at a first brightness, and at least one light source constituting the second light source area, which corresponds to the second screen 102 without the operation right, at a second brightness which is lower than the first brightness. Thereby, the user can easily understand that the first screen 101 has the operation right. In addition, since the second screen 102 without the operation right is displayed dark, the energy consumption can be reduced.

The liquid crystal display device 100 can switch the brightness control in accordance with the transfer of the operation right. For example, in the above-described case in which the first screen 101 has the operation right and the second screen 102 does not have the operation right, the first screen 101 is controlled at the first brightness and the second screen 102 is controlled at the second brightness which is lower than the first brightness. If the operation right is transferred from the first screen 101 to the second screen 102 on the basis of the operation signal from the remote controller 10, that is, if a transition occurs to the state in which the second screen 102 has the operation right and the first screen 101 does not have the operation right, the liquid crystal display device 100 controls the second screen 102 at the first brightness and the first screen 101 at the second brightness that is lower than the first brightness, in accordance with the transfer of the operation right. In the meantime, the control module 12 manages the transfer of the operation right, etc.

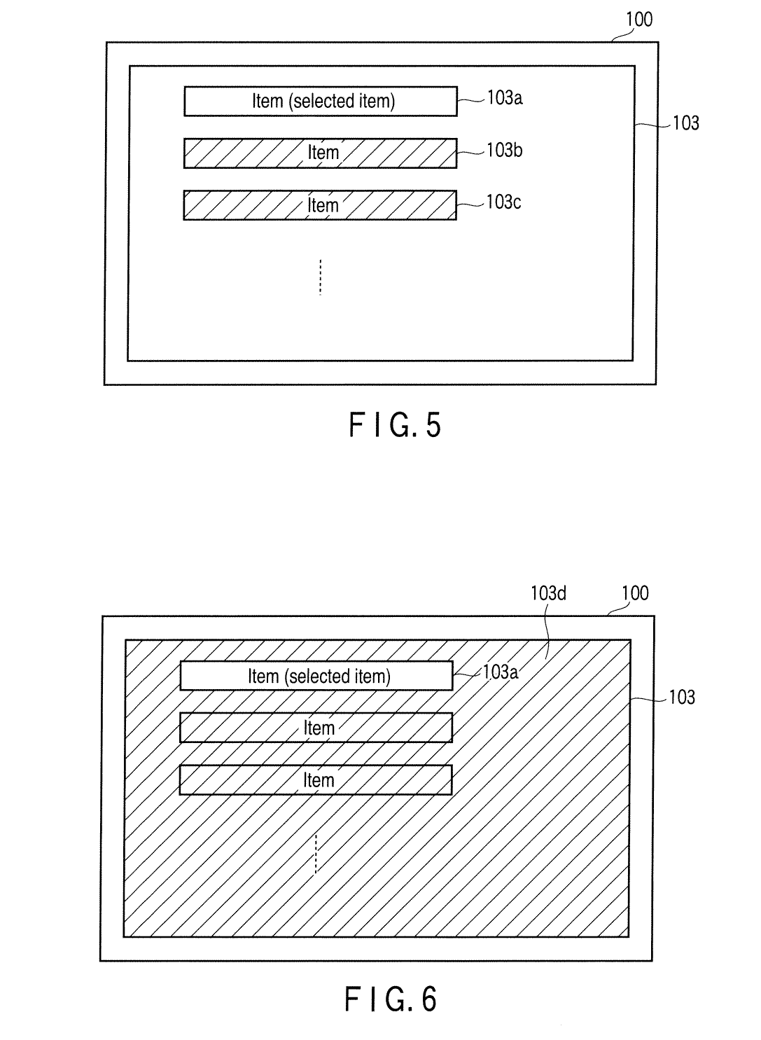

As shown in FIG. 5, the liquid crystal display device 100 can control a selected item 103a (selected area), which is included in items of a menu screen 103 and is focused by a cursor, at the first brightness, and can control the other items 103b and 103c, excluding this selected item, at the second brightness that is lower than the first brightness.

In another example, as shown in FIG. 6, the liquid crystal display device 100 can control the selected item 103a (selected area), which is included in the plural items of the menu screen 103 and is focused by the cursor, at the first brightness, and can control the other area 103d, excluding this selected item, at the second brightness that is lower than the first brightness.

In still another example, the liquid crystal display device 100 controls the selected area at the first brightness and the non-selected area at the second brightness, as described above, and can control, after the passing of a predetermined time (e.g. after one minute), the selected area and the non-selected area at the same brightness. For example, after the passing of a predetermined time (e.g. after one minute), the liquid crystal display device 100 controls the selected area and the non-selected area at the first brightness.

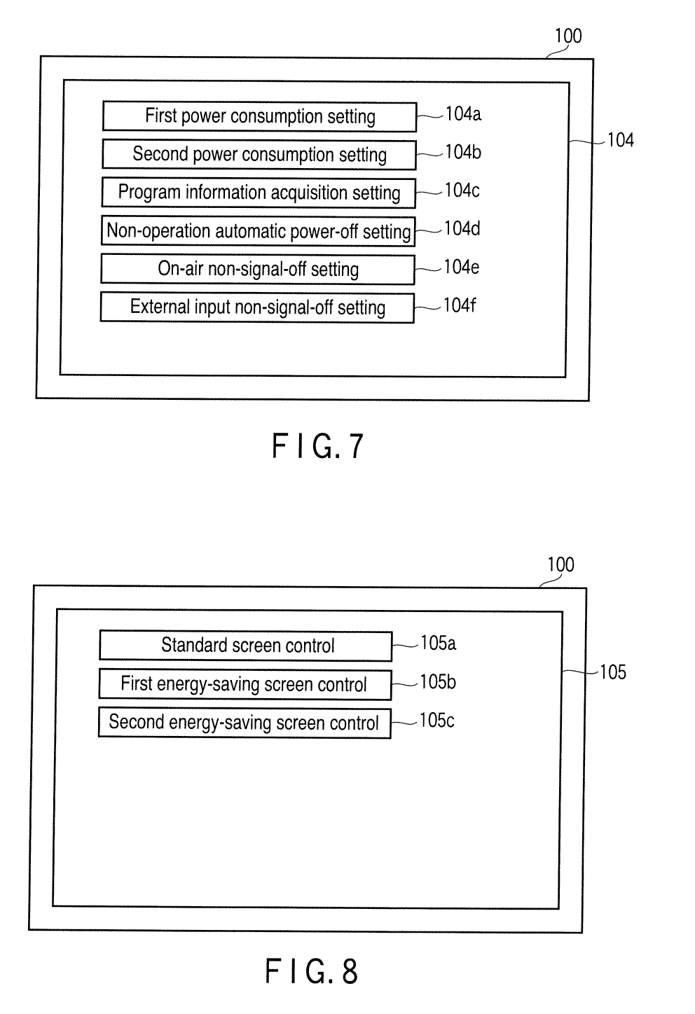

Next, mode setting is described. FIG. 7 shows an example of an energy-saving setting screen 104. As shown in FIG. 7, for example, the energy-saving setting screen 104 includes items of first power consumption setting 104a, second power consumption setting 104b, program information acquisition setting 104c, non-operation automatic power-off setting 104d, on-air non-signal-off setting 104e, external input non-signal-off setting 104f.

If the first power consumption setting 104a of the energy-saving setting screen 104 is selected on the basis of an operation signal from the remote controller 10, items of “standard brightness”, “low brightness A” and “low brightness B”, for instance, are displayed. If the item of “standard brightness” is selected, the control module 12 stores the selected standard brightness, and the liquid crystal display device 100 displays an image with the standard brightness on the basis of the control of the control module 12. If the item of “low brightness A” is selected, the control module 12 stores the selected low brightness A, and the liquid crystal display device 100 displays an image with the low brightness A, which is lower than the standard brightness, on the basis of the control of the control module 12. If the item of “low brightness B” is selected, the control module 12 stores the selected low brightness B, and the liquid crystal display device 100 displays an image with the low brightness B, which is lower than the low brightness A, on the basis of the control of the control module 12.

If the second power consumption setting 104b of the energy-saving setting screen 104 is selected on the basis of an operation signal from the remote controller 10, the liquid crystal display device 100 displays an area control setting screen 105. As shown in FIG. 8, for example, the area control setting screen 105 includes items of standard screen control 105a, first energy-saving screen control 105b and second energy-saving screen control 105c. If the item of the standard screen control 105a is selected, the control module 12 stores the selected standard screen control, and the liquid crystal display device 100 displays the selected area and non-selected area with the same brightness, without displaying the selected area and non-selected area with different brightnesses as described above. For example, in the case where the standard brightness is set, the selected area and non-selected area are displayed with the standard brightness. In the case where the low brightness A is set, the selected area and non-selected area are displayed with the low brightness A. In the case where the low brightness B is set, the selected area and non-selected area are displayed with the low brightness B.

If the item of the first energy-saving screen control 105b is selected, the control module 12 stores the selected first energy-saving screen control 105b, and the liquid crystal display device 100 displays the selected area with a predetermined brightness and the non-selected area with a brightness lower than the predetermined brightness, as described above. For example, in the case where the standard brightness is set, the selected area is displayed with the standard brightness and the non-selected area is displayed with the low brightness A that is lower than the standard brightness. In the case where the low brightness A is set, the selected area is displayed with the low brightness A and the non-selected area is displayed with the low brightness B that is lower than the standard brightness A. In the case where the low brightness B is set, the selected area is displayed with the low brightness B and the non-selected area is displayed with a low brightness C that is lower than the standard brightness B.

If the item of the second energy-saving screen control 105c is selected, the control module 12 stores the selected second energy-saving screen control 105c, and the liquid crystal display device 100 displays the selected area with a predetermined brightness and the non-selected area with a brightness lower than the predetermined brightness, as described above, and controls, after the passing of a predetermined time (e.g. after one minute), the selected area and non-selected area are controlled at the same brightness. For example, in the case where the standard brightness is set, the selected area is displayed with the standard brightness and the non-selected area is displayed with the low brightness A that is lower than the standard brightness and, after the passing of a predetermined time period, the selected area and the non-selected area are displayed with the standard brightness. In the case where the low brightness A is set, the selected area is displayed with the low brightness A and the non-selected area is displayed with the low brightness B that is lower than the standard brightness A and, after the passing of a predetermined time period, the selected area and the non-selected area are displayed with the low brightness A. In the case where the low brightness B is set, the selected area is displayed with the low brightness B and the non-selected area is displayed with the low brightness C that is lower than the standard brightness B and, after the passing of a predetermined time period, the selected area and the non-selected area are displayed with the low brightness B.

If the program information acquisition setting 104c of the energy-saving setting screen 104 is selected on the basis of an operation signal from the remote controller 10, for example, items of “acquire” and “not acquire” are displayed. If the item of “acquire” is selected, program information is acquired when the main power is in the “OFF” standby state. If the item of “not acquire” is selected, program information is not acquired when the main power is in the “OFF” standby state.

If the non-operation automatic power-off setting 104d of the energy-saving setting screen 104 is selected on the basis of an operation signal from the remote controller 10, for example, items of “standby” and “not operate” are displayed. In the case where the item of “standby” is selected, power supply stops if a non-operation state has continued for about 3 hours, and a transition occurs to the standby state. If the item of “not operate” is selected, power supply does not stop even if a non-operation state continues.

If the on-air non-signal-off setting 104e of the energy-saving setting screen 104 is selected on the basis of an operation signal from the remote controller 10, for example, items of “standby” and “not operate” are displayed. In the case where the item of “standby” is selected, power supply stops if a non-signal state has continued for about 15 minutes at a time of broadcast reception, and a transition occurs to the standby state. If the item of “not operate” is selected, power supply does not stop even if a non-signal state continues.

If the external input non-signal-off setting 104f of the energy-saving setting screen 104 is selected on the basis of an operation signal from the remote controller 10, for example, items of “standby” and “not operate” are displayed. In the case where the item of “standby” is selected, power supply stops if a non-signal state has continued for about 15 minutes at a time of selection of an external input, and a transition occurs to the standby state. If the item of “not operate” is selected, power supply does not stop even if a non-signal state continues.

The above description has been given of the brightness control by the light sources constituting the backlight. However, the brightness control of the present invention is applicable to the display device having no backlight. Thereby, even in the display device with no backlight, the visibility can be improved and the energy consumption can be reduced.

The various modules of the device described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a brightness controller configured to be capable of controlling a brightness of a backlight, which is configured to light sources, in units of a predetermined area corresponding to at least one said light source, and configured to control at a first brightness at least one said light source constituting a first light source area corresponding to a selected area on a display area, and to control at a second brightness at least one said light source constituting a second light source area corresponding to a non-selected area on the display area; and
a display module configured to display the selected area in accordance with the control at the first brightness by the brightness controller, and to display the non-selected area in accordance with the control at the second brightness by the brightness controller.

2. The device of claim 1, wherein the display module is configured to a liquid crystal panel for displaying an image on the display area, and
the liquid crystal panel is configured to modulate light from the light source.

3. The device of claim 2, wherein the display module is configured to divide the display area into screens and to be capable of displaying an image on each of the screens, and
the brightness controller is configured to control at the first brightness at least one said light source constituting the first light source area corresponding to a selected screen of the screens, which has an operation right, and to control at the second brightness lower than the first brightness at least one said light source constituting the second light source area corresponding to a non-selected screen of the screens, which has no operation right.

4. The device of claim 3, wherein the brightness controller is configured to control, when the selected screen that is controlled at the first brightness has been transitioned to the non-selected screen, at least one said light source constituting the first light source area corresponding to the transitioned non-selected screen at the second brightness, and to control, when the non-selected screen that is controlled at the second brightness has been transitioned to the selected screen, at least one said light source constituting the second light source area corresponding to the transitioned selected screen at the first brightness.

5. The device of claim 2, wherein the display module is configured to be capable of displaying items in the display area, and
the brightness controller is configured to control at the first brightness at least one said light source constituting the first light source area corresponding to a selected item of the items, and to control at the second brightness lower than the first brightness at least one said light source constituting the second light source area corresponding to a non-selected item of the items.

6. The device of claim 1, wherein the brightness controller is configured to control at the first brightness at least one said light source constituting the first light source area, to control at the second brightness at least one said light source constituting the second light source area, and to control, after passing of a predetermined time, the at least one light source constituting the first light source area and the at least one light source constituting the second light source area at the same brightness.

7. The device of claim 1, wherein the brightness controller is configured to control, on the basis of selection of a first mode included in a menu screen displayed in the display area, at least one said light source constituting the first light source area corresponding to the selected area in the display area at the first brightness, and at least one said light source constituting the second light source area corresponding to the non-selected area at the second brightness, and the brightness controller is configured to control, on the basis of selection of a second mode included in the menu screen displayed in the display area, at least one said light source constituting the first light source area corresponding to the selected area in the display area at the first brightness, and at least one said light source constituting the second light source area corresponding to the non-selected area at the second brightness, and to control, after passing of a predetermined time, the at least one light source constituting the first light source area corresponding to the selected area and the at least one light source constituting the second light source area corresponding to the non-selected area at the same brightness.

8. A display method comprising:
controlling at a first brightness at least one light source constituting a first light source area corresponding to a selected area on a display area, and controlling at a second brightness at least one light source constituting a second light source area corresponding to a non-selected area on the display area; and
displaying the selected area in accordance with the controlling of the first light source area at the first brightness, and displaying the non-selected area in accordance with the controlling of the second light source area at the second brightness.
